(19) United States
(12) Patent Application Publication
(10) Pub. No.: US 2015/0348428 A1
(43) Pub. Date: Dec. 3, 2015

(54) Interactive Detection Training Systems

(71) Applicant: GSE SYSTEMS, INC., Sykesville, MD (US)

(72) Inventor: Michael Kenneth Lerg, Cary, NC (US)

(73) Assignee: GSE SYSTEMS, INC., Sykesville, MD (US)

(21) Appl. No.: 14/725,651

(22) Filed: May 29, 2015

Related U.S. Application Data
(63) Continuation-in-part of application No. 62/004,444, filed on May 29, 2014.

(51) Int. Cl. G09B 5/02; G09B 19/24

(52) U.S. Cl. CPC G09B 5/02; G09B 19/24

(57) ABSTRACT

An interactive detection training system has a testing space with a defined perimeter and testing space coordinates, a virtual hot zone detecting probe, a probe motion tracker positioned in the detecting probe, a virtualization display unit, and a simulation system.

### CROSS-REFERENCE TO RELATED APPLICATION

This application claims priority to U.S. Provisional Application No. 62/004,444, filed May 29, 2014.

### FIELD OF THE INVENTION

The invention generally relates to a contamination detection training system, and, more specifically, to an interactive contamination detection training system using physical devices in a virtual environment.

### BACKGROUND

Industries using hazardous materials, such as radioactive materials, chemicals, or biological agents, have an ongoing need for sophisticated screening procedures to address public safety concerns relating to public exposure to the hazardous materials. While many sensitive detecting devices have been developed to identify the presence of various hazardous materials, these devices must be properly operated in order to be effective. As such, operators of the detecting devices require formal training on the operation and proper technique of the devices. However, the operational training needs to be done without exposing the operator to possible contamination.

Various conventional detection training systems have been developed that attempt to provide a realistic, simulated training environment using a variety of different approaches. For example, one conventional approach is to use a simulated detecting device to receives radiofrequency (RF) signals or detects magnetic fields from embedded transmitters or magnets in a physical testing body, such as a mannequin. However, this approach is limited in that the simulated contamination zone is a fixed location that is not customizable. Additionally, the sensitivity of the detecting device is directly proportional to the detecting device's proximity to the contamination source, which this conventional approach fails to realistically simulate.

Another conventional approach is to use a control system to transmit a signal to the simulated detecting device, which then displays a simulated contamination reading. The signal is controlled by an instructor, who can actively vary the signal to decrease or increase the level of the simulated contamination reading. While this approach permits an instructor to customize the training environment by varying the location of the simulated contamination zone, the quality of the training experience is directly dependent on the instructor's skill at controlling the signal to the simulated detecting device. Additionally, it is difficult to train a student how to position the detecting device at a proper distance and orientation from the simulated contamination zone.

### SUMMARY

One of the objects of the invention, among others, is to overcome or alleviate one or more of the disadvantages described above.

An interactive detection training system has a testing space with a defined perimeter and testing space coordinates, a virtual hot zone detecting probe, a probe motion tracker positioned in the detecting probe, a virtualization display unit, and a simulation system.

### BRIEF DESCRIPTION OF THE DRAWINGS

The invention will now be described by way of example with reference to the accompanying figures, of which:

FIG. 1 shows a perspective view of an interactive detection training system;

FIG. 2 shows a perspective view of the interactive detection training system;

FIG. 3 shows a block diagram of the interactive detection training system;

FIG. 4 show a perspective view of a sensor positionable relative to a virtual hot zone and a front view of a gauge;

FIG. 5 shows a perspective view of a sensor proximate to a virtual hot zone and a front view of a gauge;

FIG. 6 shows a schematic view of a 3D avatar model of a testing body and a schematic view of a display of a virtual hot zone module on a visualization display unit;

FIG. 7 shows a perspective view of an interactive meter survey training system;

FIG. 8 shows a perspective view of the interactive meter survey training system;

FIG. 9 shows a perspective view of a user at a first distance from a visualization display unit;

FIG. 10 shows a perspective view of a user at a second distance from a visualization display unit;

FIG. 11 shows a perspective view of a user in a survey mode and a front view of a gauge;

FIG. 12 shows a perspective view of a user in a survey mode and a front view of a gauge;

FIG. 13 shows a perspective view of a 3D virtual reality learning environment having a virtual hot zone;

FIG. 14 shows a perspective view of a 3D virtual reality learning environment; and

FIG. 15 shows a block diagram of the interactive meter survey training system.

### DETAILED DESCRIPTION

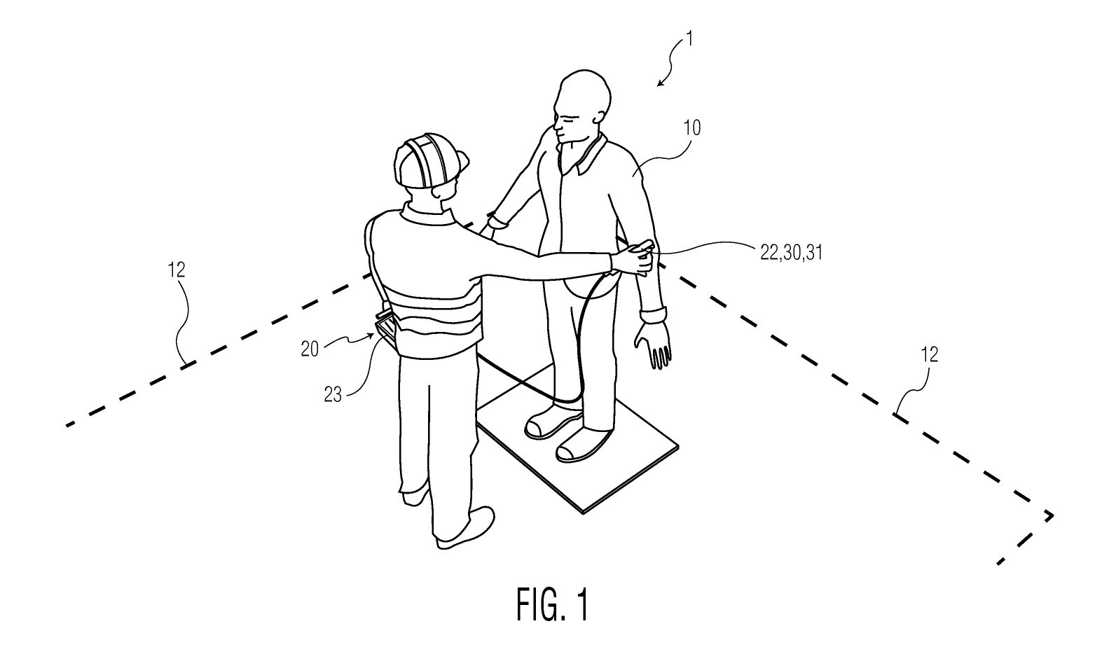

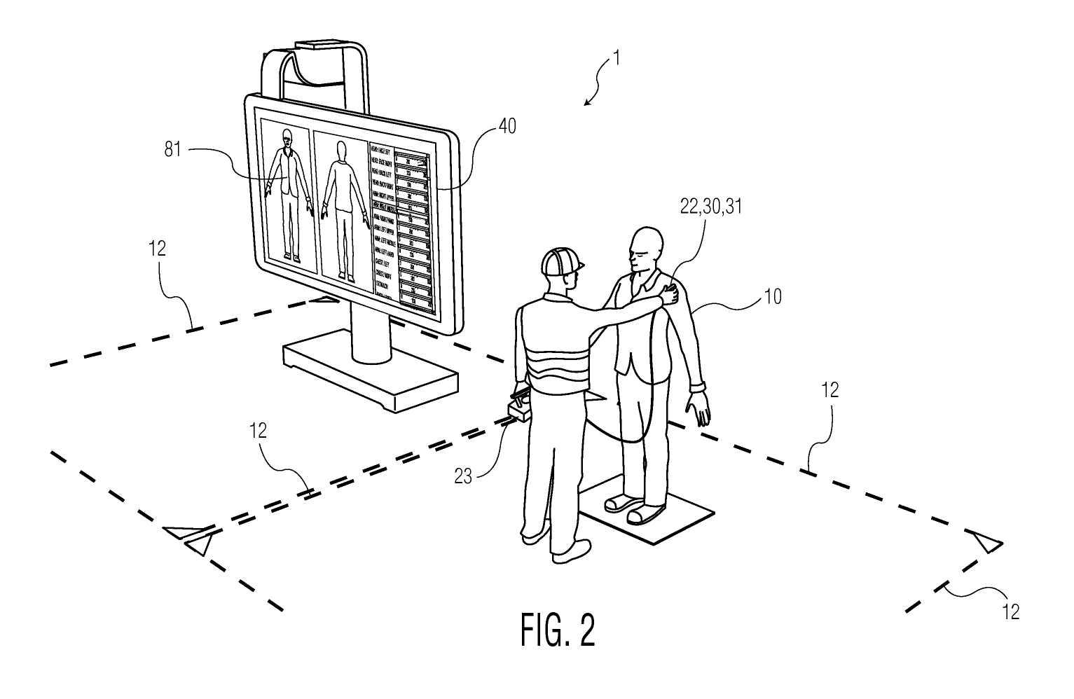

An interactive detection training system 1 is disclosed having a testing body 10, a testing space 12, a virtual hot zone detecting probe 20, a probe motion tracker 30, a virtualization display unit 40, and a simulation system (not shown). See FIGS. 1-2. Each of these components will now be described in further detail.

The testing body 10 can be any physical object that may be exposed to radiation contamination in an industrial environment. It should be understood by those of ordinary skill in the art that, while the following embodiments of the invention are radiation detection training systems, the invention includes detection of other hazards, such as, but not limited to biohazards, gasses, detectable hazardous materials, weapons such as knives or firearms, and/or metals. Accordingly, where the description recites a hot spot or a hot zone, those terms are used in a generic sense to include a spot or zone of radiation as well as any other detectable hazard, such as, but not limited, to bio hazards, gasses, detectable hazardous materials, weapons such as knives or firearms, and/or metals In an embodiment, the testing body 10 is a humanoid mannequin 11. See FIG. 1. In another embodiment, the testing body 10 is a machine, plumbing, or any other common industrial equipment found in commercial applications.

The testing space 12 is an area of physical space having predetermined and defined spatial dimensions, such as a defined length, width and height. See FIGS. 1 and 2.

In the embodiment shown, the virtual hot zone detecting probe 20 is a simulated radiation meter, such as a Geiger counter that is a replica of common original equipment manufacturers (OEM) radiation meters. See FIGS. 1 and 2. An exemplary embodiment of the simulated radiation meter is the Teletrix Simulated Radiation Meters made by Teletrix (www.teletrix.com), although those of ordinary skill in the art would appreciate that other simulated radiation meters that are replicas of OEM radiation meters may also be used. In other embodiments the sensor and meter can be the types that detect other hazards, such as the other detectable hazards discussed above.

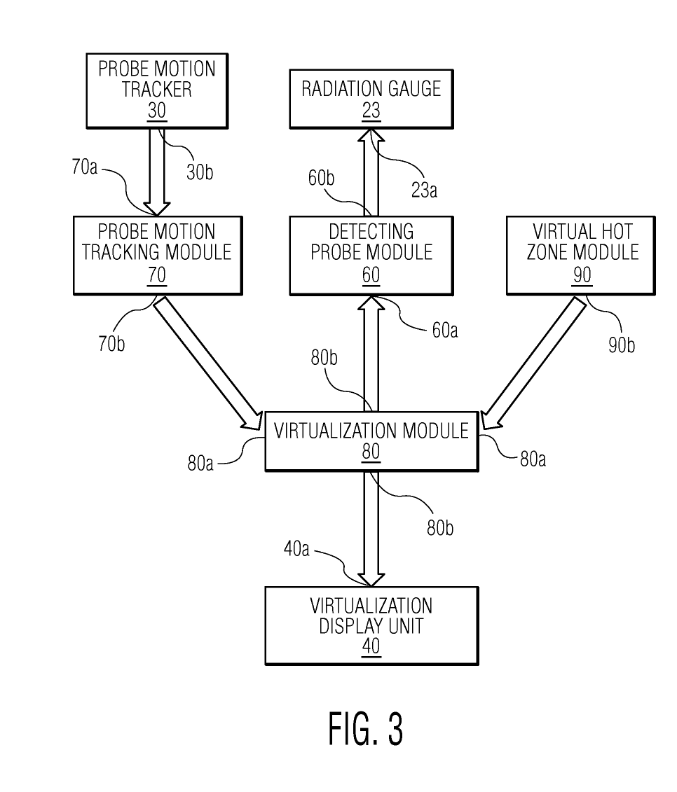

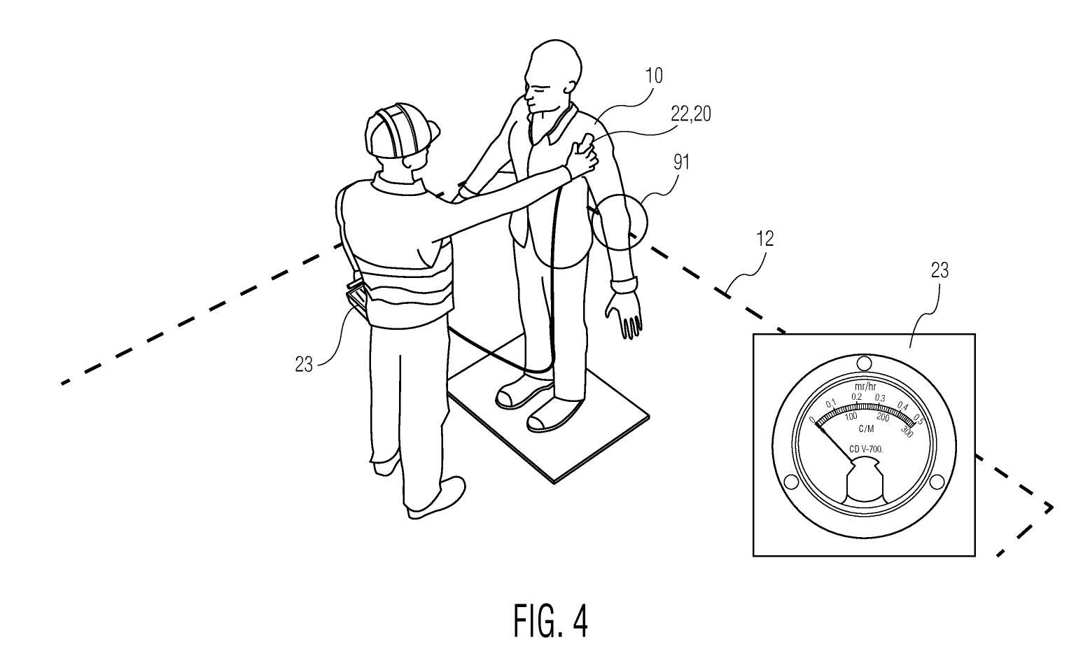

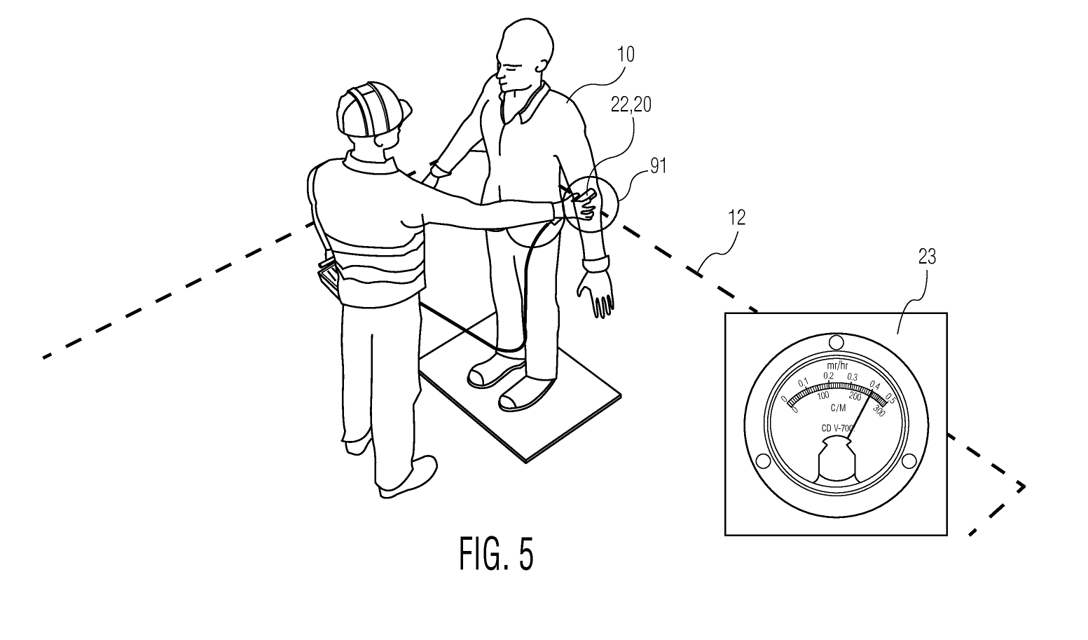

In an embodiment, the detecting probe 20 includes a simulated sensor 22 and a simulated gauge 23, which in this case is a simulated Geiger counter indicating radiation. See FIGS. 4 and 5. The simulated gauge 23 displays a simulated radiation reading across a range of radiation levels and includes an input 23a. See FIGS. 3 and 4. Either the sensor 22 or the gauge 23 has the capability of generating audio cues in addition to the displayed level.

The probe motion tracker 30 is positioned in the sensor 22. and includes a marker 31. See FIGS. 1 and 2. The marker 31 tracks its freedom of movement in a three-dimensional (3D) space. In an embodiment, the marker 31 detects six degrees of freedom (6 DoF). The 6 DoF includes the translation movement of the marker 31 in three perpendicular axes, including forward/backward, up/down and left/right, as well as the rotation of the marker 31 about the three perpendicular axes, including pitch, yaw, and roll. In another embodiment, the marker 31 detects 3 DoF. The 3 DoF includes translational movement of the marker 31 in three perpendicular axes, including forward/backward, up/down and left/right. The probe motion tracker 30 includes an output 30b. An exemplary embodiment of the probe motion tracker 30 and marker 31 is the 6 DoF electromagnetic motion trackers developed by Polhemus, Inc (www.polhemus.com). The probe motion tracker 30 and the marker 31 can be either wireless or tethered or a combination of both. One of ordinary skill in the art would appreciate that other 6 DoF or 3 DoF motion trackers may also be used.

The virtualization display unit 40 has an input 40a. In an embodiment, the virtualization display unit 40 is a computer screen or monitor or a television. In another embodiment, the interactive radiation detection training system 1 has a plurality of virtualization display units 40. In another embodiment, the interactive radiation detection training system 1 has two virtualization display units 40.

In an embodiment, the simulation system (not shown) is a computer having a processor and a memory storage device. The simulation system includes a plurality of software modules, including a detecting probe module 60, a probe motion tracking module 70, a virtualization module 80, and a virtual hot zone module 90. See FIG. 3. The detecting probe module 60 has an input 60a and an output 60b. The probe motion tracking module 70 has an input 70a and an output 70b. The virtualization module 80 has an input 80a and an output 80b. The virtual hot zone module 90 has an output 90b.

The assembly and function of the major components of the interactive detection training system 1 will now be described in detail.

The three dimensional coordinates and location of the testing space 12 is determined and mapped. The testing body 10 is positioned in a predetermined location located within the defined testing space 12. The spatial position of the testing body 10 is calibrated relative to the testing body's 10 three dimensional coordinates within the testing space 12. Hereinafter, the testing body's 10 three dimensional coordinates within the testing space 12 will be defined as the “testing body coordinates.” The calibration of the spatial position of the testing body 10 is made using common calibration techniques known to those of ordinary skill in the art. Generally the calibration is made by placing the testing body 10 in the predetermined position within the testing space 12 and a numerical values corresponding to the testing body coordinates are determined. These numerical values are entered into the simulation system.

The input 60a of the detecting probe module 60 is connected to the output 80b of the virtualization module 80. Additionally, the output 60b of the detecting probe module 60 is connected to the input 23a of the gauge 23. See FIG. 3. The detecting probe module 60 can be wirelessly connected to the gauge 23, or the detecting probe module 60 can be connected to the gauge 23 by a wire or cable. The output 60b of the detecting probe module 60 sends signals to input 23a of the gauge 23, driving the gauge 23 to display a preset level reading, in the case of this embodiment, a preset radiation level reading. The gauge 23 receives the signal, and subsequently displays the preset radiation level driven by the detecting probe module 60. An audible feedback may also be generated by the sensor 22 or gauge 23. The radiation level reading is variable, such that the detecting probe module's 60 can drive the gauge 23 to display any radiation level reading within the gauge's 23 range of radiation levels. See FIGS. 4 and 5.

The probe motion tracker 30 is positioned within the detecting probe 20. In an embodiment, the marker 31 is positioned in the sensor 22. The input 70a of the probe motion tracking module 70 is connected to the output 30b probe motion tracker 30. In an embodiment, the probe motion tracking module 70 is connected to the marker 31. The probe motion tracking module 70 can be wirelessly connected to the marker 31, or the probe motion tracking module 70 can be connected to the marker 31 by a wire or cable.

The marker 31 is placed within the testing space 12 and the spatial position of the marker 31 is calibrated relative to the marker's 31 three dimensional coordinates within the testing space 12. Hereinafter, the marker's 31 three dimensional coordinates within the testing space 12 will be defined as the “marker coordinates.” Those of ordinary skill in the art would appreciate that the marker coordinates are interchangeable with the detecting probe 22 three dimensional coordinates within the testing space 12, referred to as the “detecting probe coordinates”, and that the terms “marker coordinates” and “detecting probe coordinates” may be used interchangeably. The calibration of the spatial position of the marker 31 is made using common calibration techniques known to those of ordinary skill in the art. Generally, the marker 31 is placed in a predetermined position within the testing space 12 and the marker 31 is calibrated relative to the predetermined position. The output 30b of the probe motion tracker 30 sends a signal containing numerical values of the marker coordinates to the input 70a of the probe motion tracking module 70 detailing the movement of the marker 31 within the 6 DoF, so that the probe motion tracking module 70 can track the marker coordinates within the testing space 12 as the marker 31 moves.

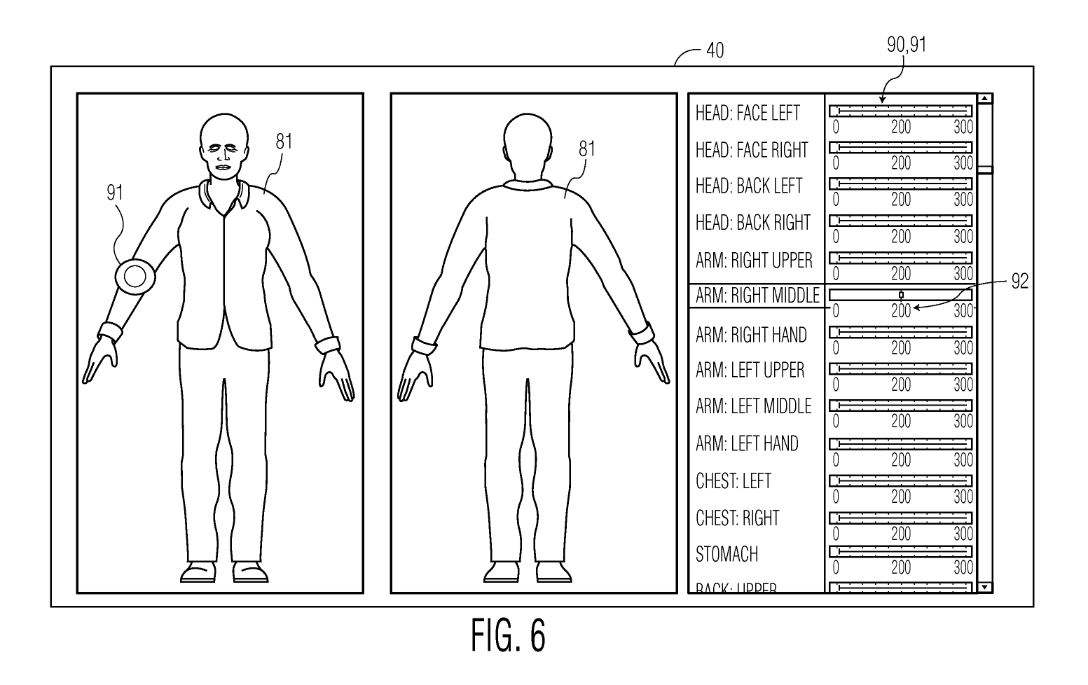

The output 80b of the virtualization module 80 is connected to the input 40a of the virtualization display unit 40. See FIG. 3. The input 40a of the virtualization display unit 40 receives signals from the output 80b of the virtualization module 80. The virtualization module 80 creates a virtual 3D avatar 81 of the testing body 10, which is then displayed on the virtualization display unit 40. See FIGS. 2 and 6.

The input 80a of the virtualization module 80 is connected to the output 70b of the probe motion tracking module 70. See FIG. 3. The probe motion tracking module 70 can be wirelessly connected to the virtualization module 80, or the probe motion tracking module 70 can be connected to the virtualization module 80 by a wire or cable. The probe motion tracking module 70 sends the virtualization module 80 the numerical values corresponding to the marker coordinates within the testing space 12. Since the numerical values corresponding to the testing body coordinates within the testing space 12 are known, the virtualization module 80 creates a virtual image of the detecting probe 20, and sends the virtual image and marker coordinates to the virtualization display unit 40. See FIGS. 2 and 3. The virtualization display unit 40 displays the virtual image of the detecting probe 20 and positions the virtual image proximate to the virtual 3D avatar 81, such that the positional relationship of the virtual image of the detecting probe 20 to the virtual 3D avatar 81 corresponds to the positional relationship of the actual detecting probe 20 to the actual testing body 10. As the detecting probe 20 is moved with respect to the testing body 10, the virtual image of the detecting probe 20 correspondingly moves with respect to the virtual 3D avatar 81.

The output 90b of the virtual hot zone module 90 is connected to the input 90a virtualization module 80. See FIGS. 3 and 6. An instructor or user enters numerical values of 3D coordinates, corresponding to an area of testing space 12 occupied by a portion of the testing body 10, into the virtual hot zone module 90. The virtual hot zone module 90 uses these numerical values of 3D coordinates to create a virtual hot zone 91. Hereinafter, the virtual hot zone's 91 three dimensional coordinates within the testing space 12 will be defined as the “hot zone coordinates.”

Since the virtual hot zone 91 is virtual, and not an actual radiological hot zone, and virtually occupies the same 3D coordinates as a portion of the testing body 10, the virtual hot zone 91 corresponds to a hidden, simulated radiation contamination area on the testing body 10. The virtual hot zone module 90 sends the numerical values of the hot zone coordinates to the virtualization module 80. The virtualization module 80 identifies the shared numerical values of the hot zone coordinates and the testing body coordinates, and directs the virtualization display unit 40 to display the virtual 3D avatar 81 having a, contrasting color highlighted region of the virtual 3D avatar 81 having the same numerical value of the hot zone coordinates. The location and size of the virtual hot zone 91 displayed on the virtual 3D avatar 81 is variable, and can be positioned anywhere on the virtual 3D avatar 81 by entering the corresponding numerical values of the hot zone coordinates. See FIG. 6. Additionally, a level 92 of the virtual hot zone 91 can be set to a value within the range of levels displayable by the gauge 23 by entering the value into the virtual hot zone module 90. See FIG. 6.

The output 80b of the virtualization module 80 is connected to the input 60a of the detecting probe module 60. See FIG. 3. The virtualization module 80 can be wirelessly connected to the detecting probe module 60, or the virtualization module 80 can be connected to the detecting probe module 60 by a wire or cable. When the detecting probe coordinates are proximate to the predetermined hot zone coordinates, the virtualization module 80 sends a signal to the detecting probe module 60, and the gauge 23 displays a radiation level reading corresponding to the radiation level set for the virtual hot zone 91. See FIGS. 4 and 5. FIG. 4 shows the gauge 23 displaying a low level reading when the 3D coordinates of the sensor 22 are different from the hot zone coordinates. FIG. 5 shows the gauge 23 displaying a high level reading when the 3D coordinates of the sensor 22 are proximate to the hot zone coordinates.

The simulation system further includes a recording sub-module (not shown), which records all of the information shown on the visualization display unit 40 onto the memory storage device. The recording can then be displayed on the visualization display unit 40 and replayed as a teaching tool to view the location, speed, and area surveyed by the detecting probe 20. Color visualizations can be displayed that correspond to the areas surveyed by the detecting probe 20, and areas not surveyed can also be displayed in contrasting colors.

An exemplary embodiment of an interactive detection training method for training a user to survey for simulated contamination is disclosed, the method comprising the steps of the user 300 holding the virtual hot zone detecting probe 20 while standing in the testing space 12. An instructor entering a location or numerical values of hot zone coordinates to correspond to a portion of the testing body 10 having those same 3D coordinates. The user 300 moving the detecting probe 20 proximate to the testing body 10. The virtualization display unit 81 displaying a virtual image of the detecting probe 20 proximate to the virtual 3D avatar. The gauge 23 displaying a reading when the detecting probe 20 is proximate to the hot zone coordinates. Lastly, the recording sub-module is recording the simulation shown on the virtualization display unit 81.

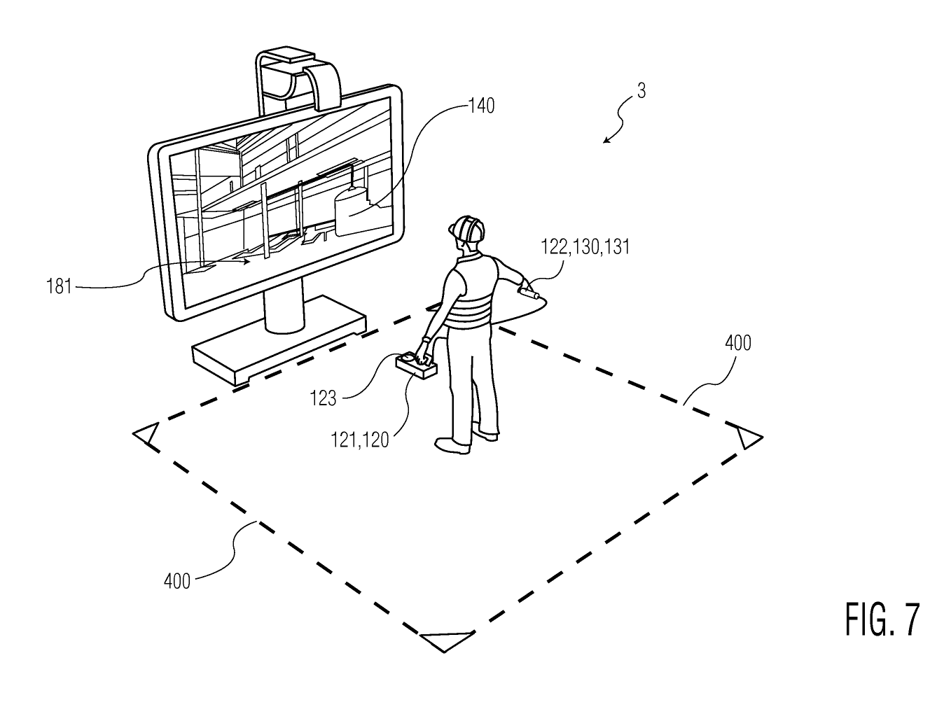

An interactive meter survey training system 3 is disclosed having a testing space 400, a virtual hot zone detecting probe 120, a probe motion tracker 130, a virtualization display unit 140, and a simulation system (not shown). See FIG. 7.

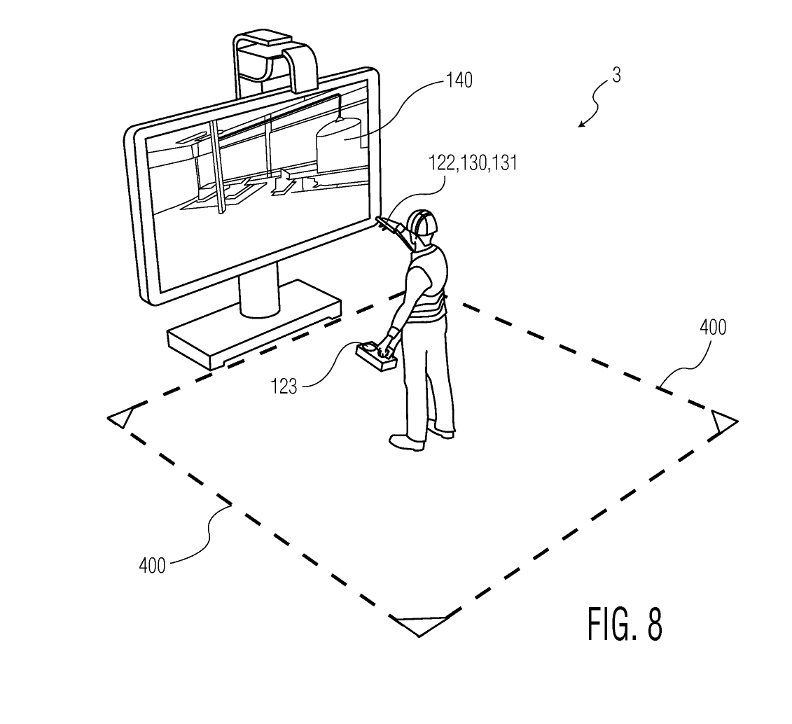

The testing space 400 is an area of physical space having predetermined and defined spatial three dimensional coordinates, such as a defined length, width and height. See FIGS. 7 and 8.

It should be understood by those reasonable skilled in the art that while the following embodiments of the invention are radiation detection training systems, the invention includes detection of other hazards, such as, but not limited to bio hazards, gasses, detectable hazardous materials, weapons such as knives or firearms, and/or metals. Accordingly, where the description recites a hot spot or a hot zone, those terms are used in a generic sense to include a spot or zone of radiation as well as any other detectable hazard, such as, but not limited, to bio hazards, gasses, detectable hazardous materials, weapons such as knives or firearms, and/or metals. In an embodiment, the virtual hot zone detecting probe 120 is a simulated radiation meter, such as a Geiger counter, that is a replica of common original equipment manufacturers (OEM) radiation meters. See FIG. 7. An exemplary embodiment of the simulated radiation meter is the Teletrix Simulated Radiation Meters made by Teletrix (www.teletrix.com), although those of ordinary skill in the art would appreciate that other simulated radiation meters that are replicas of OEM radiation meters may also be used. In other embodiments, the detecting probe 120 can be of a type that detects other hazards.

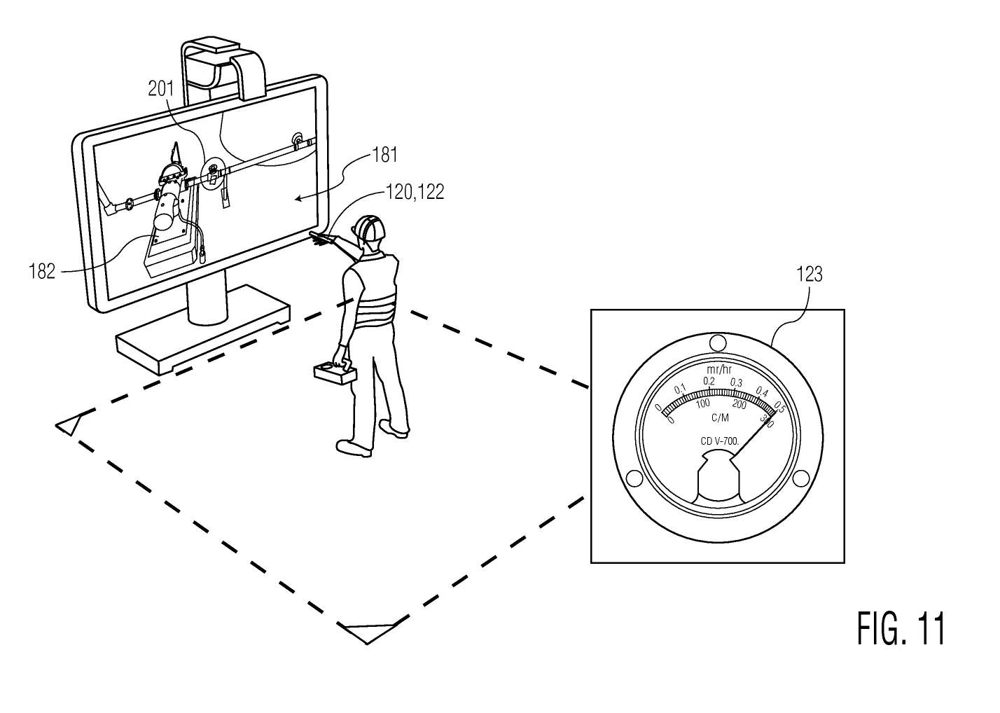

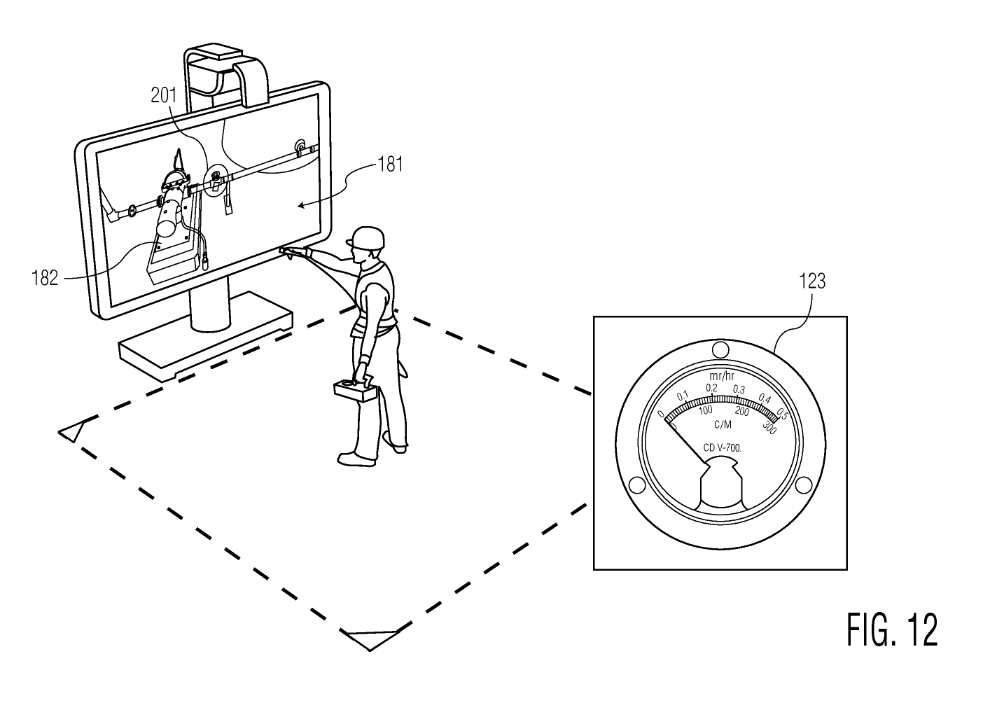

The detecting probe 120 includes a simulated sensor 122 and a simulated gauge 123. See FIG. 7. The simulated gauge 123 displays, in an embodiment shown in FIG. 7, a simulated radiation reading across a range of radiation levels and includes an input 123a. See FIGS. 11 and 12. Either the sensor 122 or the gauge 123 has the capability of generating audio cues in addition to the displayed level.

The probe motion tracker 130 is positioned in the sensor 122 and includes a marker 131. See FIG. 1. The marker 131 is a device that tracks its movement in a 3D space. In an embodiment, the marker 131 detects 6 DoF. The 6 DoF includes the translational movement of the marker 131 in three perpendicular axes, including forward/backward, up/down and left/right, as well as the rotation of the marker 131 about the three perpendicular axes, including pitch, yaw, and roll. The probe motion tracker 130 includes an output 130b. In another embodiment, the marker 131 detects 3 DoF. The 3 DoF includes translational movement of the marker 131 in three perpendicular axes, including forward/backward, up/down and left/right. An exemplary embodiment of the probe motion tracker 130 and marker 131 is the 6 DoF electromagnetic motion trackers developed by Polhemus, Inc (www.polhemus.com). The probe motion tracker 130 and the marker 131 can be either wireless or tethered or a combination of both. One of ordinary skill in the art would appreciate that other 6 DoF or 3 DoF motion trackers may also be used.

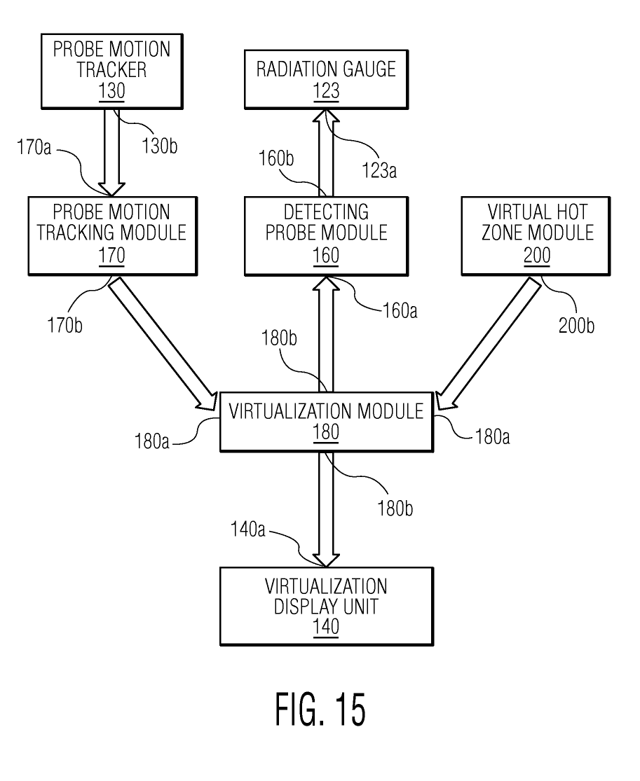

The virtualization display unit 140 has an input 140a. See FIG. 15. In an embodiment, the virtualization display unit 140 is a computer screen or monitor or a television. In another embodiment, the interactive radiation meter survey training system 3 has a plurality of virtualization display units 140. In another embodiment, the interactive radiation meter survey training system 3 has one virtualization display unit 140.

In an embodiment, the simulation system (not shown) is a computer having a processor and a memory storage device. The simulation system includes a plurality of software modules, including a detecting probe module 160, a probe motion tracking module 170, a virtual hot zone module 200, and a virtualization module 180. See FIG. 15. The detecting probe module 160 has an input 160a and an output 160b. The probe motion tracking module 170 has an input 170a and an output 170b. The virtual hot zone module 200 has an output 200b. The virtualization module 180 has an input 180a and an output 180b.

The assembly and function of the major components of the interactive radiation meter survey training system 3 will now be described in detail.

The virtualization display unit 140 is positioned in a predetermined location within the testing space 400. The spatial position of the virtualization display unit 140 is calibrated relative to the virtualization display unit's 140 3D coordinates within the testing space 400 (hereinafter referred to as the “testing space coordinates”). The calibration of the spatial position of the virtualization display device 140 is made using common calibration techniques known to those of ordinary skill in the art. Generally, the calibration is made by placing the virtualization display unit 140 in a predetermined position within the testing space 400 and assigning numerical values corresponding to the 3D coordinates of the virtualization display unit 140 (hereinafter referred to as the “display unit coordinates”). These numerical values are entered into the simulation system.

The output 160b of the detecting probe module 160 is connected to the input 120a of the virtual hot zone detecting probe 120. See FIG. 15. In an embodiment, the detecting probe module 160 is connected to the gauge 123. The detecting probe module 160 can be wirelessly connected to the gauge 123, or the detecting probe module 160 can be connected to the gauge 123 by a wire or cable. The output 160b of the detecting probe module 160 sends signals to input 123a of the gauge 123, driving the gauge 123 to display a predetermined radiation level reading. The gauge 123 receives the signal, and subsequently displays the predetermined level driven by the detecting probe module 160. The level reading is variable, such that the detecting probe module 160 can drive the gauge 123 to display any level reading within the gauge's 123 range of levels. An audible feedback may also be generated by the sensor 122 or gauge 123. See FIGS. 11 and 12. FIG. 11 shows the gauge 123 displaying a high level reading when the sensor 122 is proximate to the virtual hot zone 201. FIG. 12 shows the gauge 123 displaying a low level reading when the sensor 122 is far from the virtual hot zone 201.

The probe motion tracker 130 is positioned within the detecting probe 120. In an embodiment, the marker 131 is positioned in the sensor 122. The input 170a of the probe motion tracking module 170 is connected to the output 130b of the probe motion tracker 130. In an embodiment, the probe motion tracking module 170 is connected to the marker 131. The probe motion tracking module 170 can be wirelessly connected to the marker 131, or the probe motion tracking module 170 can be connected to the marker 131 by a wire or cable.

The marker 131 is placed within the testing space 400 and the spatial position of the marker 131 is calibrated relative to the marker's 131 3D coordinates within the testing space 400 (hereinafter referred to as the “marker coordinates”). The calibration of the spatial position of the marker 131 is made using common calibration techniques known to those of ordinary skill in the art. Generally, the marker 131 is placed in a predetermined position within the testing space 112 and the marker 131 is calibrated relative to the predetermined position. The output 130b of the probe motion tracker 130 sends a signal containing numerical values of the marker coordinate position to the input 170a of the motion tracking module 170 detailing the movement of the marker 131 within the 6 DoF, so that the motion tracking module 170 can track the marker coordinates within the testing space 400 as the marker 131 moves.

The output 180b of the virtualization module 180 is connected to the input 140a of the virtualization display unit 140. See FIG. 15. The input 140a of the virtualization display unit 140 receives signals from the output 180b of the virtualization module 180. The virtualization module 180 creates a 3D virtual reality learning environment 181, which is then sent to the virtualization display unit 140. The virtualization display unit 140 displays the 3D virtual reality learning environment 181 as an immersive, 3D environment that is viewed by the user 300 as occupying the testing space 400. See FIG. 7-12. In an embodiment, the virtualization display unit 140 displays the 3D environment using a 3D parallax view, such that the user 300 can view a stereoscopic or multiscopic image. In another embodiment, the user wears stereoscopic 3D glasses (not shown) to view the 3D environment on the virtualization display unit 140.

The 3D virtual reality learning environment 181 created by the virtualization module 180 is a virtual representation of a work environment similar to the user's 300 work environment. Exemplary examples of the 3D virtual reality learning environment 181 may include virtual representations of power plants or other spaces having a plurality of rooms with virtual representations of common industrial equipment 182 such as pumps, engines, conduit, boilers, etc located in the rooms. In other exemplary embodiments, the 3D virtual reality learning environment 181 may include virtual representations of commercial or private motor vehicles, rail cars, or rail engines. In another exemplary embodiment, the 3D virtual reality learning environment 181 may include virtual representations of residential facilities, such as residential homes. Since the location and position of the virtualization display unit 140 is calibrated with respect to the testing space 400, the 3D virtual reality learning environment 181 is viewed by the user as occupying the testing space 400. As such, the 3D coordinates of the virtual representations of common industrial equipment 182 with respect to the testing space 400 is known.

The output 200b of the virtual hot zone module 200 is connected to the input 200a of the virtualization module 180. See FIG. 15. An instructor or user enters numerical values of 3D coordinates, corresponding to the 3D coordinates of the 3D virtual reality learning environment 181 in the testing space 400, into the virtual hot zone module 90. The virtual hot zone module 200 uses these numerical values of 3D coordinates to create a virtual hot zone 201. Since the virtual hot zone 201 is virtual, and not an actual radiological hot zone and virtually occupies the same 3D coordinates as an area of the 3D virtual reality learning environment 181, the virtual hot zone 201 corresponds to a hidden, simulated radiation contamination area in the 3D virtual reality learning environment 181. The virtual hot zone module 200 sends the numerical values of the hot zone coordinates to the virtualization module 180. The virtualization module 180 identifies the shared numerical values of the hot zone coordinates and the 3D virtual reality learning environment 181 within the testing space 400, but directs the virtualization display unit 40 to hide the virtual hot zone 201 in the 3D virtual reality learning environment 181 so that the user 300 is not visually alerted to the virtual hot zone 201 during the simulation. The location and size of the virtual hot zone 201 is variable, and can be positioned anywhere in the virtual reality learning environment 181 by entering the corresponding numerical values of the hot zone coordinates. See for example, FIG. 6 discussed above for the virtual hot zone module 90. Additionally, the level value of the virtual hot zone 201 can be set to a value within the range of levels displayable by the gauge 123. See for example, FIG. 6 described above for the virtual hot zone module 90.

The input 180a of the virtualization module 180 is connected to the output 170b of the probe motion tracking module 170. See FIG. 15. The probe motion tracking module 170 can be wirelessly connected to the virtualization module 180, or the probe motion tracking module 170 can be connected to the virtualization module 180 by a wire or cable. The probe motion tracking module 170 sends the virtualization module 180 the marker coordinates, and the virtualization module 180 tracks the marker's 131 location within the testing space 400 with respect to the 3D coordinates of the virtualization display unit 140 and the virtual representations of the common industrial equipment 182.

The output 180b of the virtualization module 180 is also connected to the input 160a of the detecting probe module 160. See FIG. 15. The virtualization module 180 can be wirelessly connected to the detecting probe module 160, or the virtualization module 180 can be connected to the detecting probe module 160 by a wire or cable.

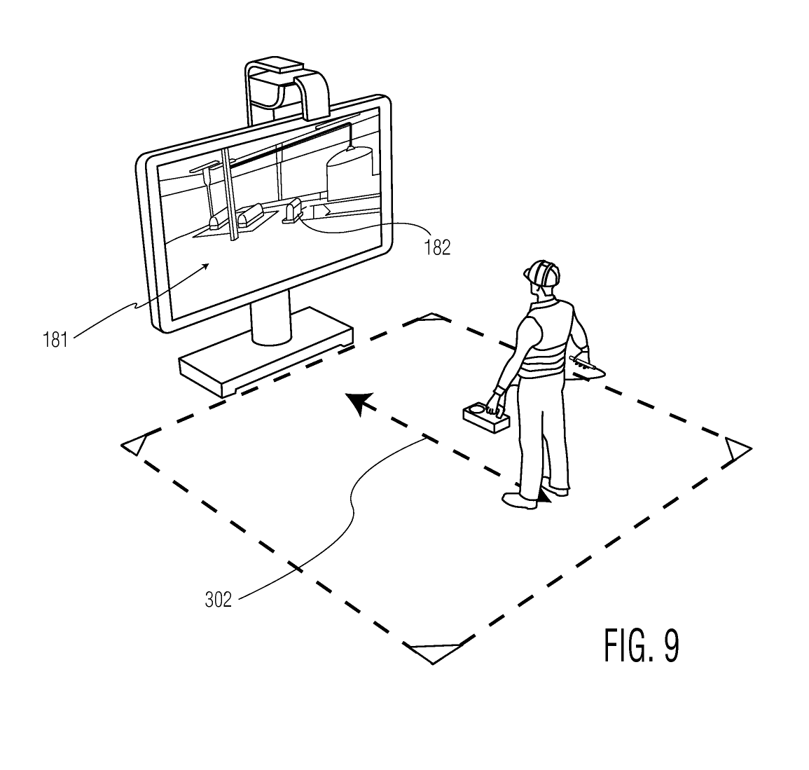

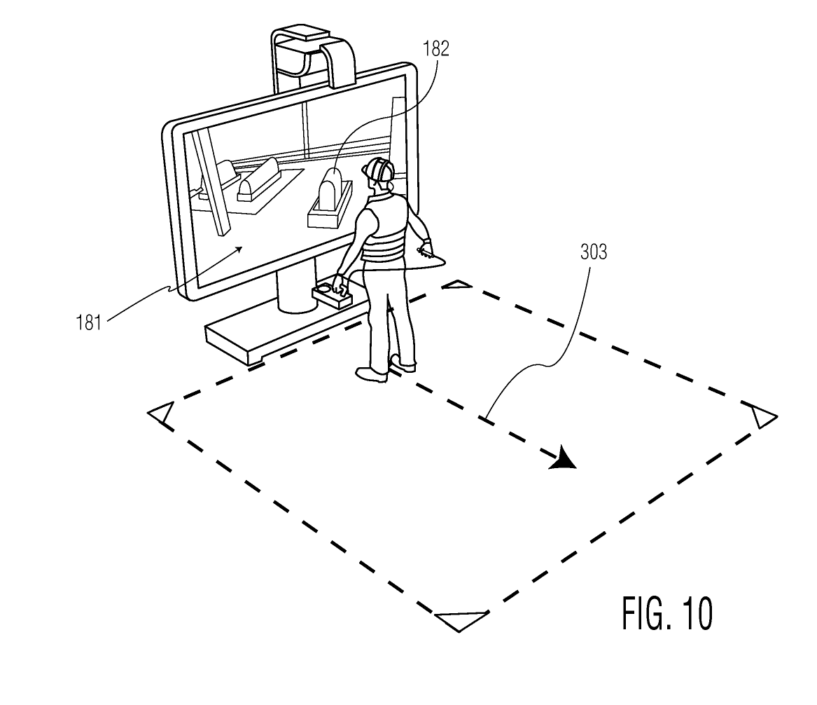

The virtualization module 180 uses the marker coordinates to adjust the 3D virtual reality learning environment 181 displayed on the virtualization display unit 140 to match the user's 300 point of view with the user's 300 physical position relative to the physical position of the virtualization display unit 140. See FIGS. 9 and 10. For example, as shown in FIG. 9, when the user 300 is positioned at a first distance 302 away from the virtualization display unit 140, an image of the 3D virtual reality learning environment 181 is displayed on the virtualization display unit 140. The further the first distance 301 is from the virtualization display unit 140, the wider the view of the 3D virtual reality learning environment 181. As shown in FIG. 10, as the user 300 moves toward the virtualization display unit 140 to a second distance 303, the image of the 3D virtual reality learning environment 181 changes as if the virtualization display unit 140 were a window into the 3D virtual reality learning environment 181. The closer the second distance 303 is from the virtualization display unit 140, the narrower the view of the 3D virtual reality learning environment 181.

The simulation system has two modes of operation, a navigation mode and a survey mode, both of which are selectable by the user 300. In the navigation mode, shown in FIG. 8, the detecting probe 120 performs as a navigation tool. Since the detecting probe 120 is motion tracked by the probe motion tracking module 170 in real time, when the user 300 points the detecting probe 120 towards a location on the virtualization display unit 140, the virtualization module 180 sends a signal to the visualization display unit 140 to display the user's 300 point of view virtually moving within the 3D virtual reality learning environments 181, using virtual stairs, doors, and around obstacles. In the navigation mode, the user's 300 point of view can be brought up to the virtual industrial equipment 182 to be surveyed for simulated radiation contamination.

In the survey mode, such as the embodiment shown in FIGS. 11 and 12, the user 300 can move the detecting probe 120 to survey the virtual industrial equipment 182 for simulated radiation contamination. Since the detecting probe 120 is motion tracked by the probe motion tracking module 170 in real time so that the detecting probe's 120 position within the testing space 400 is known, as well as the 3D coordinates of the virtual common industrial equipment 182, the movement of the detecting probe 120 with respect to the virtual industrial equipment 182 is also known. When a virtual hot zone 201 has been created on the virtual industrial equipment 182 and the sensor 122 is proximate to the virtual hot zone 201 on the virtual reality learning environment 181, the virtualization module 180 sends a signal to the detecting probe module 160, which subsequently directs the gauge 123 to display a simulated level reading corresponding to the level set in the virtual hot zone 201. See FIGS. 11 and 12. FIG. 12 shows the gauge 123 displaying a low level reading with the sensor coordinates are different from the hot zone coordinates. FIG. 11 shows the gauge 123 displaying a high level reading when the sensor coordinates are proximate to the hot zone coordinates. The simulated level reading is simulated accurately based on both the distance of the sensor 122 to the virtual hot zone 201 and the angle of the sensor 122 to the virtual hot zone 201.

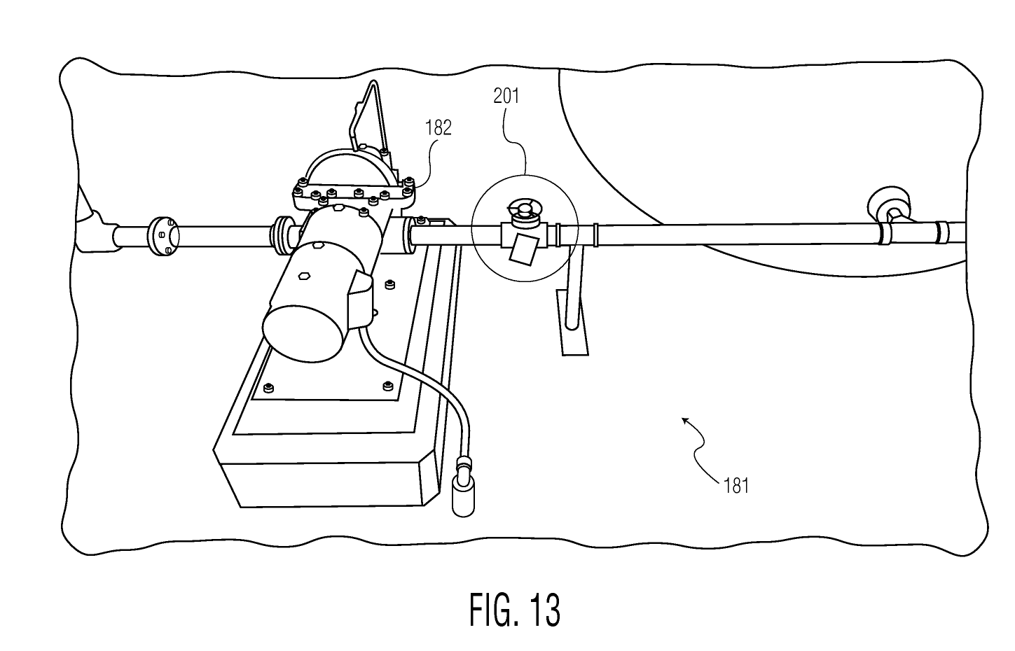

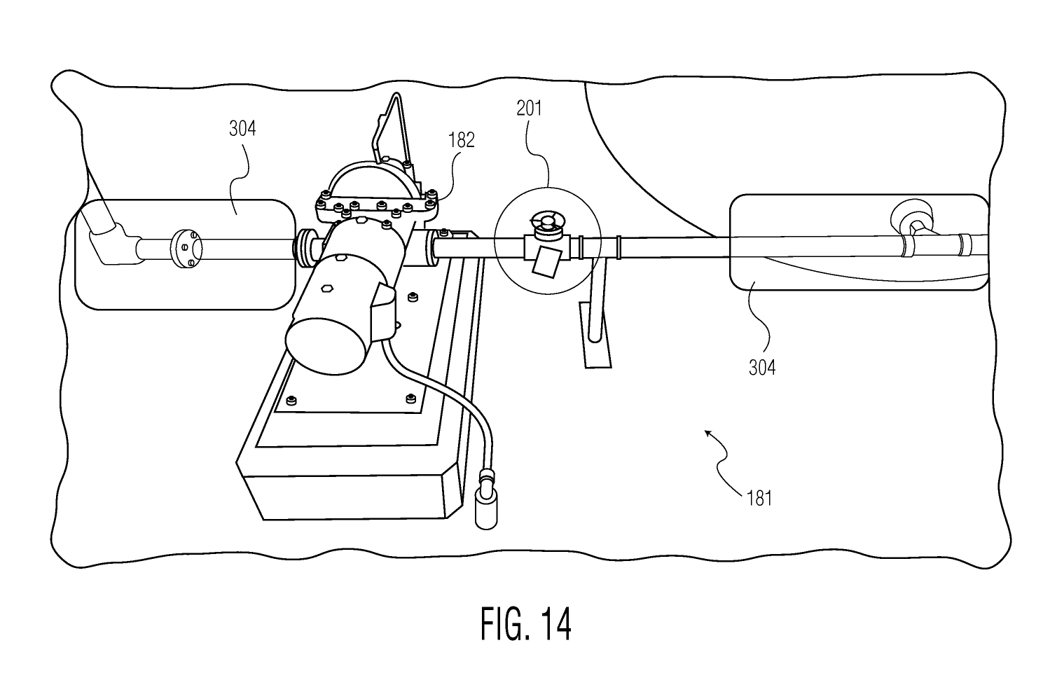

The simulation system further includes a recording sub-module (not shown), which records all of the information shown on the visualization display unit 140 onto the memory storage device. See FIGS. 13 and 14. The recording can then be displayed on the visualization display unit 140 and replayed as a teaching tool to view the location, speed, and area surveyed by the detecting probe 120. Contrasting color visualizations can be displayed that correspond to the areas surveyed by the detecting probe 120, and areas that the user 300 failed to correctly survey can also be displayed in contrasting colors. FIG. 13 shows the recording sub-module's recording of the virtual hot zone 201 proximate to the industrial equipment 182. FIG. 14 shows zones 304 where the user 300 failed to survey for contamination.

An exemplary embodiment of an interactive radiation meter survey training method for training a user to survey for simulated contamination, the method comprising the steps of the user 300 holding the virtual hot zone detecting probe 120 while standing in the 3D virtual reality learning environment 181 created in the testing space 400. An instructor entering the numerical values of hot zone coordinates to correspond to a location within the 3D virtual reality learning environment 181. The user 300 moving the detecting probe 20 within the testing space 400 in the 3D virtual reality learning environment 181. The gauge 123 displaying a reading when the detecting probe 120 is proximate to the hot zone coordinates. And the recording sub-module is recording the simulation shown on the virtualization display unit 140.

Although the above description and Figures show and describe various exemplary embodiments of the invention, one of ordinary skill in the art would appreciate that changes or modifications may be made without departing from the principles and spirit of the disclosure.

What is claimed is:

1. An interactive detection training system comprising:
a testing space having a defined perimeter and testing space coordinates;
a virtual hot zone detecting probe;
a probe motion tracker positioned in the detecting probe;
a virtualization display unit; and
a simulation system.

2. The interactive detection training system of claim 1, wherein the simulation system includes a detecting probe module connected to the detecting probe.

3. The interactive detection training system of claim 2, wherein the detecting probe includes a contamination level gauge in electronic communication with the detecting probe module.

4. The interactive detection training system of claim 3, wherein the simulation system includes a motion tracking module connected to the probe motion tracker.

5. The interactive detection training system of claim 4, wherein motion tracking module receives data having probe motion tracker coordinates of the probe motion tracker within the testing space.

6. The interactive detection training system of claim 4, wherein the probe motion tracker includes a three degrees of freedom marker or a six degrees of freedom marker in electronic communication with the motion tracking module.

7. The interactive detection training system of claim 5, further comprising a physical test body positioned in the testing space at a predetermined location having three-dimensional test body coordinates.

8. The interactive detection training system of claim 7, wherein the simulation system includes a virtualization module connected to the virtualization display unit.

9. The interactive detection training system of claim 8, wherein the simulation system includes a virtual hot zone module connected to the virtualization module.

10. The interactive detection training system of claim 9, wherein the virtualization module displays a virtual three-dimensional avatar of the physical test body on the virtualization display unit based on the test body coordinates.

11. The interactive detection training system of claim 10, wherein the virtual hot zone module communicates three dimensional hot zone coordinates to the virtualization module.

12. The interactive detection training system of claim 11, wherein the virtualization module displays the virtual hot zone on the virtualization display unit.

13. The interactive detection training system of claim 12, wherein when the hot zone coordinates have a same numerical value as the testing body coordinates, the virtual hot zone displayed on the virtualization display unit is shown as a highlighted region on the virtual three-dimensional avatar.

14. The interactive detection training system of claim 13, wherein when the probe motion tracker coordinates are proximate to the hot zone coordinates, the contamination level gauge displays a contamination reading value.

15. The interactive detection training system of claim 13, wherein when probe motion tracker coordinates are proximate to the hot zone coordinates, the detecting probe emits an audio cue.

16. The interactive detection training system of claim 13, wherein the virtualization display unit displays a virtual image of the detecting probe.

17. The interactive detection training system of claim 13, wherein the simulation system includes a recording module that records the display shown on the visualization display unit.

18. The interactive detection training system of claim 5, wherein the simulation system includes a virtualization module connected to the virtualization display unit.

19. The interactive detection training system of claim 18, wherein the simulation system includes a virtual hot zone module connected to the virtualization module.

20. The interactive detection training system of claim 19, wherein the virtualization module instructs the virtualization display unit to display a three-dimensional virtual reality learning environment as an immersive, three-dimensional environment occupying the testing space.

21. The interactive detection training system of claim 20, wherein the virtual reality learning environment includes virtual representations of physical objects positioned within the testing space, with the positions of the virtual representations having three-dimensional coordinates.

22. The interactive detection training system of claim 21, wherein the virtual hot zone module communicates three dimensional hot zone coordinates to the virtualization module.

23. The interactive detection training system of claim 22, wherein when the probe motion tracker coordinates are proximate to the hot zone coordinates, the contamination level gauge displays a contamination reading value.

24. The interactive detection training system of claim 22, wherein when the probe motion tracker coordinates are proximate to the hot zone coordinates, the detecting probe emits an audio cue.
